(19) United States
(12) Patent Application Publication
(10) Pub. No.: US 2009/0101527 A1
(43) Pub. Date: Apr. 23, 2009

(54) Remembrance booklet

(76) Inventor: Susan Triolo, Boynton Beach, FL (US)

Correspondence Address: MCHALE & SLAVIN, P.A., 2855 PGA BLVD, PALM BEACH GARDENS, FL, 33410, US

(21) Appl. No.: 11/873,840

(22) Filed: Oct. 17, 2007

(51) Int. Cl. B42D 1/00

(52) U.S. Cl. 206/232

(57) ABSTRACT

Disclosed is a Remembrance Booklet that provides a device for presentation of a ring commemorating a most important moment. The Remembrance Booklet appears as a conventional book having a concealed compartment for placement of a ring. A light may be used to highlight the compartment and a preprogrammed memory chip can activated for replaying prerecorded songs, sayings or jingles. The first part of the booklet contains sayings that a person may otherwise be at a lost to present during a critical presentation.

### FIELD OF THE INVENTION

This invention is related to novelty products and in particular to a keepsake reminder for presentation of events that include a ring.

### BACKGROUND OF THE INVENTION

There are many times in life that they remembrance of an important moment is captured by pictures, movies, or other keepsakes, but over the years may become a persons most prized possessions. Fortunately there is also a time in life where the person presenting an item may be ill-equipped for the need of creating a remembrance device for any of a number of reasons. For instance, one of the most joyful times of a young couple's relationship is in the conventional format of when the man proposes marriage to the woman. Such a proposal is a life altering commitment and typically consummated by a man presenting a ring to the woman and the woman accepting the ring as a sign of the willingness to enter into the lifelong relationship. Unfortunately most men are ill-equipped at this time in their life to make such a presentation a remembrance keepsake. For instance, the man may provide a beautiful setting at a restaurant, get down on his knee, and make a proposal all of which is captured only by the man and woman with no other remembrance. More typically, the man simply makes a proposal that may or may not be a romantic gesture. In any event, despite the best intentions of the man, the proposal may appear awkward or possibly insulting. Yet another example is a graduation gift such as a high school or college ring where the ring is presented without much fanfare yet signifies a great accomplishment by the individual.

Thus what is lacking in the art is a device capable of assisting an individual of the presentation of a ring and providing a lifelong remembrance device. Known prior art includes:

U.S. Pat. No. 5,226,532 discloses a gift container and greeting card holder based upon a cutout blank with three panels. The first and third panels have removable central portions defined by lines of perforations which are pulled loose by pull tabs. Assembly is achieved by folding the first and third panels onto the central second panel after the gift is entered into a containing space via open edge walls after which the panels and edge strips are sealed together. The gift holding area is not limited in its construction.

U.S. Pat. No. 5,282,537 discloses a combination gift article that simultaneously provides the features of a photo frame, gift box and greeting card. The device includes two swivably connected panels that open and close with respect to each other. One or both of the panels may display a photograph and, with both panels opened, serve as a photo frame. The combination gift article has a gift container mounted on one of the panels that may contain a small gift and/or a photograph.

U.S. Pat. No. 5,081,776 discloses a greeting card structure, in which framed artwork is displayed, and the greeting card can be transformed into structure enabling the framed artwork to be hung from a wall. The greeting card comprises a pair of relatively rigid panels interconnected by a flexible sheet. The framed artwork is secured to one of the panels. The flexible sheet forms an integral hinge which enables the panels to pivot between open and closed positions and is further adapted to carry a message which can be read when the card is in an open position.

U.S. Pat. No. 5,575,384 discloses a combined greeting card and commemorative carrier wherein the card has a receptacle greeting panel having a sleeve for receiving and another greeting panel to secure the greeting card about the item located in the carrier. A hidden cradle is used for placement of an item for storage and display.

U.S. Pat. No. 5,277,307 discloses a gift and greeting card having a rigid box with an open front with a finished perimeter. A small gift may be removably positioned within the interior of the box with lighting means to illuminate the gift. A reversible panel is slidingly movable in grooves formed in side frame members at the box open front to conceal and reveal the gift as desired. A multi-page greeting card may be positioned forwardly of the panel in the grooves with the back page thereof including a hole through which the panel, and subsequently the gift, may be viewed upon removal of the panel.

U.S. Pat. No. 1,143,729 discloses a combined post card and candy container. The inside of the cover includes pages (10) that can carry text messages with a receptacle 8 for holding of a gift, in this case candy.

U.S. Pat. No. 4,203,516 discloses a novelty greeting card having front and rear panels hingedly connected by a spine section of finite width. A block having a thickness equal to the width of the spine and the same area as the back panel is secured to the front face of the back panel. A well formed in the central portion of the block is used for holding of a dog biscuit.

U.S. Pat. No. 4,433,780 discloses a greeting card having a receptacle for holding of a standard audio cassette. The inner cover may include the greeting card and/or a picture.

U.S. Pat. No. 5,096,058 discloses a Combined Greeting Card and Candy Holder. A message panel is hingedly connected to one of the panels of the compartment so as to be folded over the candy compartment in a greeting card type of arrangement. An openable closure is provided on the candy compartment so as to permit quick and convenient access to its interior for inserting and removing a piece of candy as a gift to be included with the greeting card.

U.S. Pat. No. 5,458,235 discloses a gift product comprising a candy box with individually wrapped pieces of candy, and a greeting card formed in one piece with the candy box. The greeting card panel has an outside surface which is visible to a person holding the gift product when the panel is in the closed position and an inside surface which is visible to a person holding the gift product when the panel is in the open position. The front wall of the candy box has a window through which candy can be viewed when the panel is in the open position. The outside and inside surfaces of the greeting card panel, and the individual candy wrappers all have a common personal sentiment thereon, so that when the gift product is closed the common personal sentiment is conveyed by the outside surface of the panel, and when the gift product is opened, the common personal sentiment is conveyed by the inside surface of the.

U.S. Pat. No. 6,070,719 discloses a greeting card and gift box combination made from a single sheet of cardboard-like box stock having a gift box member with a window for viewing a gift mounted therein, a greeting message on the gift box member above the window, a greeting card front flap hingedly attached to a side of the gift box member, an envelop cover integrated into the front flap to selectively hide a greeting or message viewable through a frame or window in the outside panel of the front flap, and a gift mount system for mounting a gift within the gift box member.

U.S. Pat. No. 7,204,048 discloses a generally planar panel and a plurality of opposing retaining members disposed on the panel. The plurality of opposing retaining members may be arranged to retain a substantially rectangular transaction card having a first longitudinal axis in a first orientation with respect to the panel and to retain a substantially rectangular paper gift having a second longitudinal axis in a second orientation with respect to the panel, so that the orientation of the first longitudinal axis is substantially transverse to the second orientation of the second longitudinal axis.

U.S. Pat. No. 5,063,698 discloses a greeting card with an electronic recording. When the greeting card is opened, a switch can be depressed to activate a preprogrammed greeting.

### SUMMARY OF THE INVENTION

Disclosed is a ring remembrance device which consists of a booklet-type box that while in a closed position resembles a small hard bound book. Each page has a predefined thickness so as to create the resemblance of a small book wherein the first part of the booklet includes foldable pages that is available for placement for poems or sayings, or maybe preprinted with poems or sayings directed to the particular moment. Beneath the foldable pages is a cavity for holding of a ring wherein the booklet operates as a ring holder with a combination of foldable pages allowing for a greeting card type format. Within the confines of the ring holder may be included a small illumination device so as to allow illumination of the ring upon opening of the last page. The light causing particular reflection for jewelry such as diamonds. In addition, the last page may further operate a music or prerecorded voice playback so as to highlight the revealing of the ring. Removal of the ring leaves a device that can be used for holding of the ring in the future or otherwise provide a permanent remembrance of the moment including the words spoken at the important event such as the marriage proposal.

Thus an objective of the instant invention is to provide a remembrance device for use in presentation of a ring.

Still another objective of the instant invention is to provide a greeting card/ring holder type booklet that makes it simpler for a marriage proposal by providing important words at a time that a man may be at a loss for words.

Still another objective of the instant invention is to provide a device that highlights a ring in a presentation format by use of light and/or music.

Still another objective of the instant invention is to provide a casement for a ring for lifelong display. Yet still another objective of the instant invention is to create a ring holder that assimilates a booklet thereby concealing the purpose of the ring holder until a revealment of the ring is made.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objectives and features thereof.

### BRIEF DESCRIPTION OF THE DRAWINGS

FIG. 1 is a perspective view of the Remembrance Booklet of the instant invention in a closed position;

FIG. 2 is a perspective view of the Remembrance Booklet in a partially opened position;

FIG. 3 is a perspective view of the Remembrance Booklet in an opened position;

FIG. 4 is a top plain view of the booklet illustrating placement of the battery, speaker, light and ring assembly;

FIG. 5 is an electrical schematic of a simplified light switch; and

FIG. 6 is an electrical schematic of electrical system for use in providing various types of programmable sounds or music.

### DETAILED DESCRIPTION OF THE PREFERRED EMBODIMENT

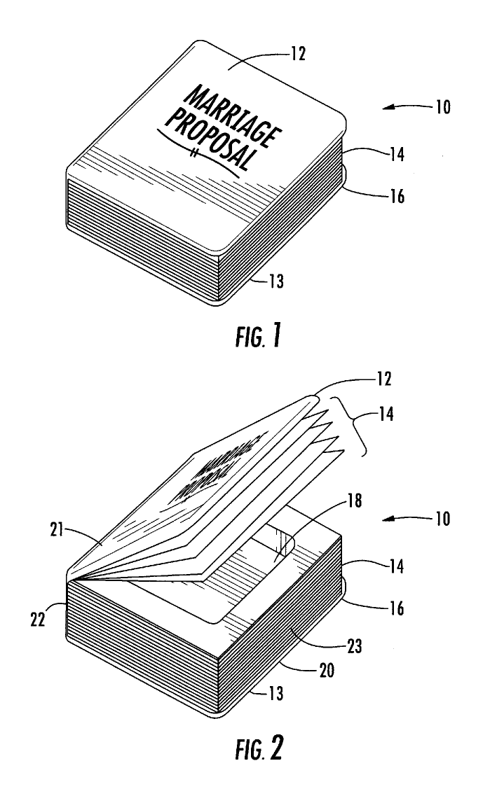

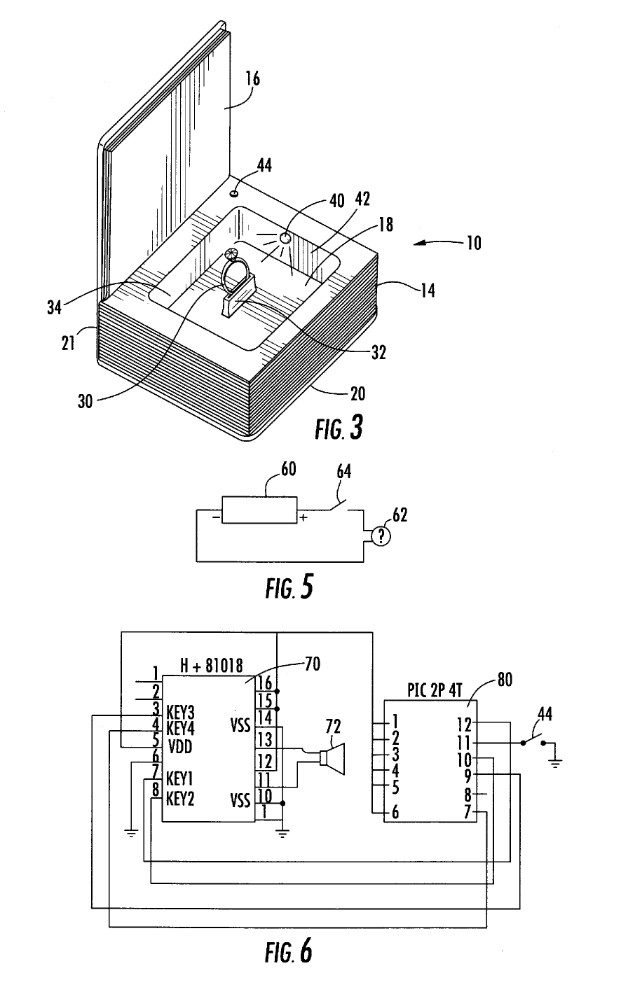

Now referring to FIG. 1, set forth is the booklet (10) which gives the appearance of a small hard bound book. The booklet (10) has a rigid front cover (12) with a plurality of individual pages (14) attached to a base (16). The individual pages (14) are of a width, length and thickness so as to provide a depth perception to the booklet. The base (16) includes a bottom portion (13) having approximately the same width, length and thickness as the rigid front cover (12) and presents the appearance of a back cover of a hard bound book. The external dimensions of the base, other than the base portion, are approximately equal to the width and length of pages (14). The height or thickness of the base is substantially greater than the thickness of pages (14). The base (16) may be made from multiple layers of paper or cardboard which are glued together or from other material such as wood or synthetic material which can be made to give the appearance of a substantial number of pages of a book. One edge of the base is configured to function and appear as a spine (21) of a typical hard bound book while the other three sides are designed to appear as the page edges (23) of a book. The base (16) includes a cavity (18) accessible only by opening of the cover (12) and pages (14). Cavity (18) has a rear base formed by the back wall (20). As in a conventional booklet, a hinge (22) which is attached to the spine edge of base (16) allows the pages to be rotated to an open position without removal. Within the cavity (18) can be placed the remembrance item, in particular a ring (30). The ring is secured to the inner wall of the back cover (20) by a base (32) so as to prevent movement while in position. Base (32) may take the form of a post, a slot, a pillow or any other suitable arrangement for presenting the ring. The side walls (34) of the cavity can be lined with a reflective material to highlight the ring. A light (40) may be placed along a side wall (42) and made operational by pressure switch (44) so that when the pages (14) have been opened the light is turned on to highlight the ring. The reflective walls (34) provide illumination enhancement with minimal battery drain. The pages can be blank or more preferably provided with pre-prepared sayings such as the following examples:

### EXAMPLE 1

I love you when . . .

I kiss you,

When I hold you close,

When we're laughing,

And when we're sharing our love together.

So let's share our lives together, too.

Marry me.

### EXAMPLE 2

How can I tell you how much you mean to me?

I can take you in my arms,

I can kiss you and tell you I love you,

I can tell you how happy I am when I'm with you,

And I can ask you to spend the rest of your life with me.

Marry me.

### EXAMPLE 3

Because I love you I came here today,

To let you know in a special way,

That I want to be with you for the rest of my life,

That is why I am asking you to be my wife.

Will you marry me?

### EXAMPLE 4

It's hard for me to find the words to tell you how much I love you.

You have made my life complete in every way.

That is why I want to spend the rest of my life with you.

Marry me.

### EXAMPLE 5

Before I met you, my life was empty.

You have made my heart full and my days happy.

Let's be together forever.

Marry me.

### EXAMPLE 6

Today is the day

That you will see

How much I want you

To be with me

I love you so much

In every way

And want you near me

Every day

So without hesitation

What I plan to do

Is get down on my knees

And propose to you

Will you marry me?

### EXAMPLE 7

When we met we liked each other, and got along very well.

We took walks together.

We had dinner together often.

We liked to talk about the same things.

And watch TV together, too.

I don't think we should ever be apart.

So, will you marry me?

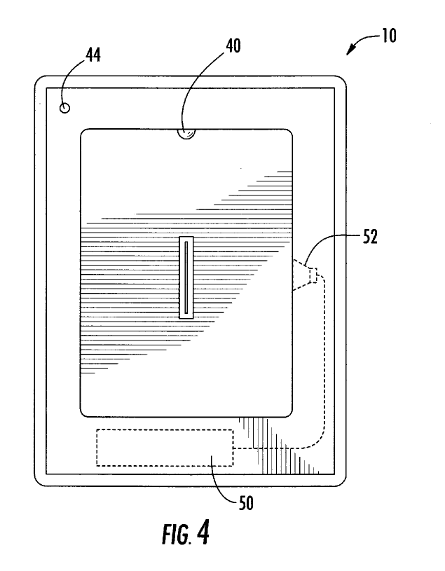

FIG. 4 depicts a top plain view of the Remembrance Booklet depicting the light (40) with pressure switch (44). In addition, is shown placement of battery (50) which couples to the circuitry for operation of the light. In addition, a speaker (52) may be incorporated in conjunction with a microchip as will be further explained that allows various types of music or poems to be played upon the opening of the pages and release of the pressure switch (44). The book can be maintained in a closed position by a number of methods, such as the ribbon, tie, loop & pile attachment or strap. Alternative a magnet may be placed in the cover for use in maintaining the booklet in a closed position. The use of such a positive closing mechanism helps to prevent accidental loss of the ring should the booklet be inverted. Now referring to FIG. 5 shown is a simple light circuit having a battery (60) connected to a light (62) operated by a pressure switch (44). The light is preferably a LED light having low battery drain wherein the battery may be small, lithium based capable of providing power for 15 or more years without charge. In this manner, the Remembrance Booklet may be maintained as a secure holding device for the ring for future review of the special moment. Referring now to FIG. 6 set forth is a sound generator (70) which is an integrated circuit capable of providing storage of various sounds such as music, poems, prerecorded messages and so forth. The sounds signals can be selected by a user by the use of selectable switches and each sound signal can run for a predefined duration such as 15 or 20 seconds. The sound generator is coupled to a speaker (72) for reproduction of the audio signal. The integrated circuit is coupled to a switching mechanism preferably a dip switch (80) which is depicted as a two pole four throw selector switch. The selector switch is coupled in conjunction with the depression actuating pressure switch (44) so as to cause operation upon opening of the booklet and exposing the cavity with the ring inside. As in combination with the light, the sound circuitry provides an ambiance to the moment that the individual opens the Remembrance Booklet. Prerecorded sound could be the first song the couple remembered when they first met should the Remembrance Booklet be a marriage proposal. Alternatively, the prerecorded sound could be the high school football song if the ring was presented in remembrance of a championship. Prerecorded songs will be provided allowing the Remembrance Booklet to be personalized to the individual using a variety of preprogrammed songs. Songs or sounds such as wedding bells, anniversary hymns and the like.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and drawings/figures.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A remembrance book with concealed receptacle comprising:
a rigid front cover,
a base portion connected to said rigid front cover, and
a plurality of pages connected to said base and said cover,
said base portion including a bottom portion-in the form of a rectangle and having side walls extending upwards there from, said side walls having interior and exterior surfaces, one of said side walls has an exterior surface that is configured as a spine of a book and the exterior surface of the other three sides are configured to appear as edges of book pages, wherein the rigid front cover and the plurality of pages are hingedly attached to the base portion on the side wall that is configured to appear as the spine of said book,
the bottom portion and said interior surfaces of said side walls define a cavity within the base portion,
wherein the cavity is accessible only by turning the rigid front cover and said plurality of pages to an open position away from said base portion.

2. The remembrance book with concealed receptacle of claim 1, wherein said plurality of pages are left blank to allow one to inscribe a personal expression or are preprinted with expressions that are appropriate to a particular occasion.

3. The remembrance book with concealed receptacle of claim 1, wherein the bottom portion of the interior cavity includes a mount to provide support for a ring contained therein.

4. The remembrance book with concealed receptacle of claim 3, wherein the interior surfaces of said side walls are covered with a reflective surface.

5. The remembrance book with concealed receptacle of claim 3, wherein the interior cavity includes a light circuit having a battery connected to a light that is operated by a pressure switch that comes in to and out of contact with the rigid front cover and said plurality of pages when they are moved to an open position away from said base portion or a closed position when they are bearing upon the base portion.

6. The remembrance book with concealed receptacle of claim 3, wherein the interior cavity includes a sound generator circuit having a battery connected to the sound generator that is operated by a pressure switch that comes in to and out of contact with the front cover and said plurality of pages when they are moved to an open position away from the base portion or a closed position when they are bearing upon the base portion.

7. The remembrance book with concealed receptacle of claim 4, wherein the interior cavity includes a light circuit having a battery connected to a light that is operated by a pressure switch that comes in to and out of contact with the rigid front cover and said plurality of pages when they are moved to an open position away from said base portion or a closed position when they are bearing upon the base portion.

8. The remembrance book with concealed receptacle of claim 5, wherein the interior cavity includes a sound generator circuit, said battery connected to the sound generator that is operated by said pressure switch when comes in to and out of contact with the front cover and said plurality of pages as they are moved to an open position away from the base portion or a closed position when they are bearing upon the base portion.

9. The remembrance book with concealed receptacle of claim 7, wherein the interior cavity includes a sound generator circuit, said battery connected to the sound generator that is operated by said pressure switch when comes in to and out of contact with the front cover and said plurality of pages as they are moved to an open position away from the base portion or a closed position when they are bearing upon the base portion.

10. The remembrance book with concealed receptacle of claim 1, wherein the rigid front cover is inscribed with an expression indicative of a special occasion.
